(19) United States
(12) Patent Application Publication
(10) Pub. No.: US 2025/0192431 A1
(43) Pub. Date: Jun. 12, 2025

(54) DUAL-BEAM SECTOR ANTENNA AND ARRAY

(71) Applicant: Outdoor Wireless Networks LLC, Richardson, TX (US)

(72) Inventors: Igor E. Timofeev, Dallas, TX (US); Martin L. Zimmerman, Chicago, IL (US); Huy Cao, Garland, TX (US); Yanping Hua, Suzhou (CN)

(21) Appl. No.: 19/059,940

(22) Filed: Feb. 21, 2025

Related U.S. Application Data
(63) Continuation of application No. 17/952,521, filed on Sep. 26, 2022, now Pat. No. 12,261,373.
Application No. 17/952,521 is a continuation of application No. 16/998,558, filed on Aug. 20, 2020, now Pat. No. 11,469,497.
Application No. 16/998,558 is a continuation of application No. 15/787,782, filed on Oct. 19, 2017, now Pat. No. 10,777,885.
Application No. 15/787,782 is a continuation of application No. 13/127,592, filed on May 4, 2011, now Pat. No. 9,831,548.
(60) Provisional application No. 61/199,840, filed on Nov. 20, 2008.

(51) Int. Cl. H01Q 3/26; H01Q 1/24; H01Q 3/28; H01Q 3/30; H01Q 3/40; H01Q 21/06; H01Q 21/24; H01Q 25/00; H01Q 25/02

(52) U.S. Cl. CPC H01Q 3/26; H01Q 1/246; H01Q 3/30; H01Q 25/002; H01Q 3/28; H01Q 3/40; H01Q 21/061; H01Q 21/24; H01Q 25/00; H01Q 25/02

(57) ABSTRACT

A low sidelobe beam forming method and dual-beam antenna schematic are disclosed, which may preferably be used for 3-sector and 6-sector cellular communication system. Complete antenna combines 2-, 3- or -4 columns dual-beam sub-arrays (modules) with improved beam-forming network (BFN). The modules may be used as part of an array, or as an independent 2-beam antenna. By integrating different types of modules to form a complete array, the present invention provides an improved dual-beam antenna with improved azimuth sidelobe suppression in a wide frequency band of operation, with improved coverage of a desired cellular sector and with less interference being created with other cells. Advantageously, a better cell efficiency is realized with up to 95% of the radiated power being directed in a desired cellular sector.

### CLAIM OF PRIORITY

This application is a continuation of U.S. patent application Ser. No. 17/952,521, filed Sep. 26, 2022, which, in turn is a continuation of U.S. patent application Ser. No. 16/998,558, filed Aug. 20, 2020 (now U.S. Pat. No. 11,469,497), which, in turn is a continuation of Ser. No. 15/787,782, filed Oct. 19, 2017 (now U.S. Pat. No. 10,777,885), which, in turn, is a continuation of Ser. No. 13/127,592, filed May 4, 2011 (now U.S. Pat. No. 9,831,548), which is a 35 U.S.C. § 371 national stage application of PCT International Application No. PCT/US2009/006061, filed Nov. 12, 2009 (published as WO 2010/059186 on May 27, 2010), which itself claims priority of U.S. Provisional Application Ser. No. 61/199,840, filed on Nov. 20, 2008 entitled Dual-Beam Antenna Array, the disclosures and contents of which are incorporated herein by reference in their entireties.

### FIELD OF THE INVENTION

The present invention is generally related to radio communications, and more particularly to multi-beam antennas utilized in cellular communication systems.

### BACKGROUND OF THE INVENTION

Cellular communication systems derive their name from the fact that areas of communication coverage are mapped into cells. Each such cell is provided with one or more antennas configured to provide two-way radio/RF communication with mobile subscribers geographically positioned within that given cell. One or more antennas may serve the cell, where multiple antennas commonly utilized and each are configured to serve a sector of the cell. Typically, these plurality of sector antennas are configured on a tower, with the radiation beam(s) being generated by each antenna directed outwardly to serve the respective cell.

In a common 3-sector cellular configuration, each sector antenna usually has a 65° 3 dB azimuth beamwidth (AzBW). In another configuration, 6-sector cells may also be employed to increase system capacity. In such a 6-sector cell configuration, each sector antenna may have a 33° or 45° AzBW as they are the most common for 6-sector applications. However, the use of 6 of these antennas on a tower, where each antenna is typically two times wider than the common 65° AzBW antenna used in 3-sector systems, is not compact, and is more expensive.

Dual-beam antennas (or multi-beam antennas) may be used to reduce the number of antennas on the tower. The key of multi-beam antennas is a beamforming network (BFN). A schematic of a prior art dual-beam antenna is shown in FIG. 1A and FIG. 1B. Antenna 11 employs a 2×2 BFN 10 having a 3 dB 90° hybrid coupler shown at 12 and forms both beams A and B in azimuth plane at signal ports 14 (2×2 BFN means a BFN creating 2 beams by using 2 columns). The two radiator coupling ports 16 are connected to antenna elements also referred to as radiators, and the two ports 14 are coupled to the phase shifting network, which is providing elevation beam tilt (see FIG. 1B). The main drawback of this prior art antenna as shown in FIG. 1C is that more than 50% of the radiated power is wasted and directed outside of the desired 60° sector for a 6-sector application, and the azimuth beams are too wide (150° @−10 dB level), creating interference with other sectors, as shown in FIG. 1D. Moreover, the low gain, and the large backlobe (about −11 dB), is not acceptable for modern systems due to high interference generated by one antenna into the unintended cells. Another drawback is vertical polarization is used and no polarization diversity.

In other dual-beam prior art solutions, such as shown in U.S. Patent application U.S. 2009/0096702 A1, there is shown a 3 column array, but which array also still generates very high sidelobes, about −9 dB.

Therefore, there is a need for an improved dual-beam antenna with improved azimuth sidelobe suppression in a wide frequency band of operation, having improved gain, and which generates less interference with other sectors and better coverage of desired sector.

### SUMMARY OF INVENTION

The present invention achieves technical advantages by integrating different dual-beam antenna modules into an antenna array. The key of these modules (sub-arrays) is an improved beam forming network (BFN). The modules may advantageously be used as part of an array, or as an independent antenna. A combination of 2×2, 2×3 and 2×4 BFNs in a complete array allows optimizing amplitude and phase distribution for both beams. So, by integrating different types of modules to form a complete array, the present invention provides an improved dual-beam antenna with improved azimuth sidelobe suppression in a wide frequency band of operation, with improved coverage of a desired cellular sector and with less interference being created with other cells. Advantageously, a better cell efficiency is realized with up to 95% of the radiated power being directed in a desired sector. The antenna beams' shape is optimized and adjustable, together with a very low sidelobes/backlobes.

In one aspect of the present invention, an antenna is achieved by utilizing a MXN BFN, such as a 2×3 BFN for a 3 column array and a 2×4 BFN for a 4 column array, where M N.

In another aspect of the invention, 2 column, 3 column, and 4 column radiator modules may be created, such as a 2×2, 2×3, and 2×4 modules. Each module can have one or more dual-polarized radiators in a given column. These modules can be used as part of an array, or as an independent antenna.

In another aspect of the invention, a combination of 2×2 and 2×3 radiator modules are used to create a dual-beam antenna with about 35 to 55° AzBW and with low sidelobes/backlobes for both beams.

In another aspect of the invention, a combination of 2×3 and 2×4 radiator modules are integrated to create a dual-beam antenna with about 25 to 45° AzBW with low sidelobes/backlobes for both beams.

In another aspect of the invention, a combination of 2×2, 2×3 and 2×4 radiator modules are utilized to create a dual-beam antenna with about 25 to 45° AzBW with very low sidelobes/backlobes for both beams in azimuth and the elevation plane.

In another aspect of the invention, a combination of 2×2 and 2×4 radiator modules can be utilized to create a dual-beam antenna.

All antenna configurations can operate in receive or transmit mode.

### BRIEF DESCRIPTION OF THE DRAWINGS

FIGS. 1A, 1B, 1C and 1D shows a conventional dual-beam antenna with a conventional 2×2 BFN;

FIG. 2A shows a 2×3 BFN according to one embodiment of the present invention which forms 2 beams with 3 columns of radiators;

FIG. 2B is a schematic diagram of a 2×4 BFN, which forms 2 beams with 4 columns of radiators, including the associated phase and amplitude distribution for both beams;

FIG. 2C is a schematic diagram of a 2×4 BFN, which forms 2 beams with 4 columns of radiators, and further provided with phase shifters allowing slightly different AzBW between beams and configured for use in cell sector optimization;

FIG. 3 illustrates how the BFNs of FIG. 1A can be advantageously combined in a dual polarized 2 column antenna module;

FIG. 4 shows how the BFN of FIG. 2A can be combined in a dual polarized 3 column antenna module;

FIG. 5 shows how the BFNs of FIG. 2B or FIG. 2C can be combined in dual polarized 4 column antenna module;

FIG. 6 shows one preferred antenna configuration employing the modular approach for 2 beams each having a 45° AzBW, as well as the amplitude and phase distribution for the beams as shown near the radiators;

FIG. 7A and FIG. 7B show the synthesized beam pattern in azimuth and elevation planes utilizing the antenna configuration shown in FIG. 6;

FIGS. 8A and 8B depicts a practical dual-beam antenna configuration when using 2×3 and 2×4 modules; and

FIGS. 9-10 show the measured radiation patterns with low sidelobes for the configuration shown in FIG. 8A and FIG. 8B.

### DETAILED DESCRIPTION OF THE PREFERRED EMBODIMENT

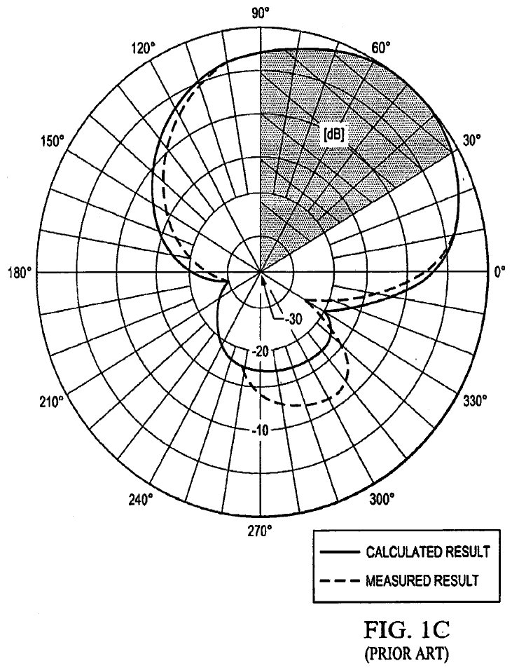

Referring now to FIG. 2A, there is shown one preferred embodiment comprising a bidirectional 2×3 BFN at 20 configured to form 2 beams with 3 columns of radiators, where the two beams are formed at signal ports 24. A 90° hybrid coupler 22 is provided, and may or may not be a 3 dB coupler. Advantageously, by variation of the splitting coefficient of the 90° hybrid coupler 22, different amplitude distributions of the beams can be obtained for radiator coupling ports 26: from uniform (1-1-1) to heavy tapered (0.4-1-0.4). With equal splitting (3 dB coupler) 0.7-1-0.7 amplitudes are provided. So, the 2×3 BFN 20 offers a degree of design flexibility, allowing the creation of different beam shapes and sidelobe levels. The 90° hybrid coupler 22 may be a branch line coupler, Lange coupler, or coupled line coupler. The wide band solution for a 180° equal splitter 28 can be a Wilkinson divider with a 180° Shiffman phase shifter. However, other dividers can be used if desired, such as a rat-race 180° coupler or 90° hybrids with additional phase shift. In FIG. 2A, the amplitude and phase distribution on radiator coupling ports 26 for both beams Beam 1 and Beam 2 are shown to the right. Each of the 3 radiator coupling ports 26 can be connected to one radiator or to a column of radiators, as dipoles, slots, patches etc. Radiators in column can be a vertical line or slightly offset (staggered column).

FIG. 2B is a schematic diagram of a bidirectional 2×4 BFN 30 according to another preferred embodiment of the present invention, which is configured to form 2 beams with 4 columns of radiators and using a standard Butler matrix 38 as one of the components. The 180° equal splitter 34 is the same as the splitter 28 described above. The phase and amplitudes for both beams Beam 1 and Beam 2 are shown in the right hand portion of the figure. Each of 4 radiator coupling ports 40 can be connected to one radiator or to column of radiators, as dipoles, slots, patches etc. Radiators in column can stay in vertical line or to be slightly offset (staggered column).

FIG. 2C is a schematic diagram of another embodiment comprising a bidirectional 2×4 BFN at 50, which is configured to form 2 beams with 4 columns of radiators. BFN 50 is a modified version of the 2×4 BFN 30 shown in FIG. 2B, and includes two phase shifters 56 feeding a standard 4×4 Butler Matrix 58. By changing the phase of the phase shifters 56, a slightly different AzBW between beams can be selected (together with adjustable beam position) for cell sector optimization. One or both phase shifters 56 may be utilized as desired.

The improved BFNs 20, 30, 50 can be used separately (BFN 20 for a 3 column 2-beam antenna and BFN 30, 50 for 4 column 2-beam antennas). But the most beneficial way to employ them is the modular approach, i.e. combinations of the BFN modules with different number of columns/different BFNs in the same antenna array, as will be described below.

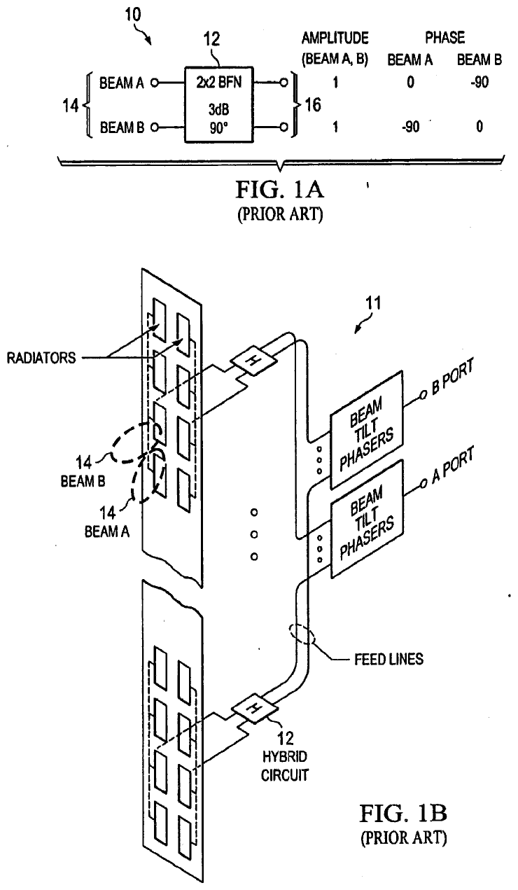

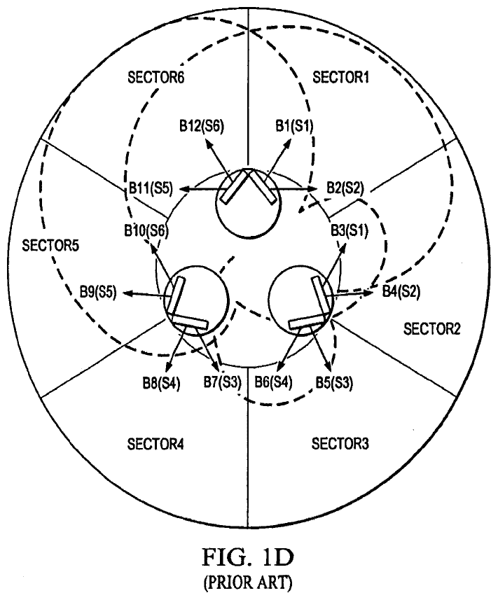

FIG. 3 shows a dual-polarized 2 column antenna module with 2×2 BFN's generally shown at 70. 2×2 BFN 10 is the same as shown in FIG. 1A. This 2×2 antenna module 70 includes a first 2×2 BFN 10 forming beams with −45° polarization, and a second 2×2 BFN 10 forming beams with +45° polarization, as shown. Each column of radiators 76 has at least one dual polarized radiator, for example, a crossed dipole.

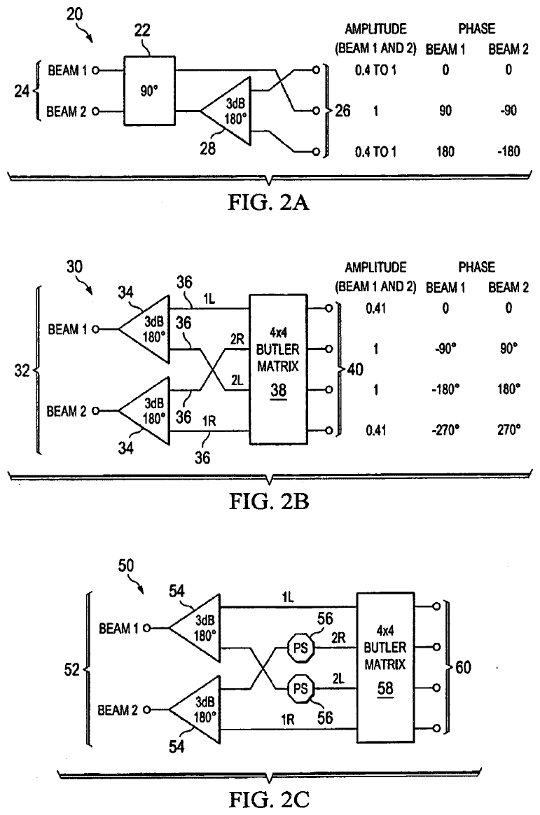

FIG. 4 shows a dual-polarized 3 column antenna module with 2×3 BFN's generally shown at 80. 2×3 BFN 20 is the same as shown in FIG. 2A. This 2×3 antenna module 80 includes a first 2×3 BFN 20 forming beams with −45° polarization, and a second 2×3 BFN 20 forming beams with +45° polarization, as shown. Each column of radiators 76 has at least one dual polarized radiator, for example, a crossed dipole.

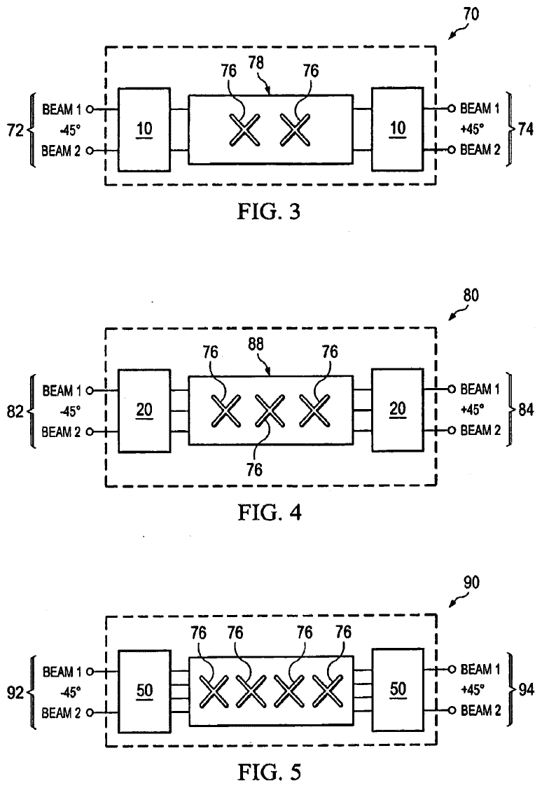

FIG. 5 shows a dual-polarized 4 column antenna module with 2×4 BFN's generally shown at 90. 2×4 BFN 50 is the same as shown in FIG. 2C. This 2×4 antenna module 80 includes a first 2×4 BFN 50 forming beams with −45° polarization, and a second 2×4 BFN 50 forming beams with +45° polarization, as shown. Each column of radiators 76 has at least one dual polarized radiator, for example, a crossed dipole.

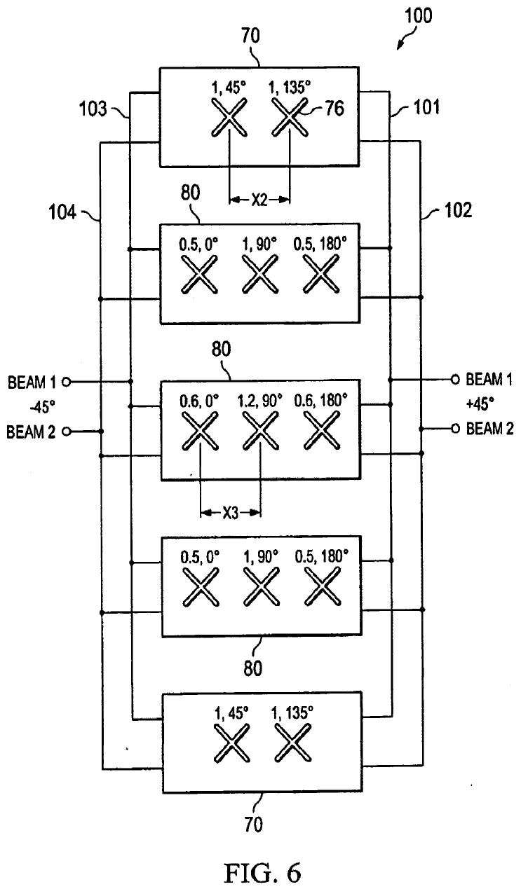

Below, in FIGS. 6-10, the new modular method of dual-beam forming will be illustrated for antennas with 45 and 33 deg., as the most desirable for 5-sector and 6-sector applications.

Referring now to FIG. 6, there is generally shown at 100 a dual polarized antenna array for two beams each with a 45° AzBW. The respective amplitudes and phase for one of the beams is shown near the respective radiators 76. The antenna configuration 100 is seen to have 3 2×3 modules 80 s and two 2×2 modules 70. Modules are connected with four vertical dividers 101, 102, 103, 104, having 4 ports which are related to 2 beams with +45° polarization and 2 beams with −45° polarization, as shown in FIG. 6. The horizontal spacing between radiators columns 76 in module 80 is X3, and the horizontal spacing between radiators in module 70 is X2. Preferably, dimension X3 is less than dimension X2, X3<X2. However, in some applications, dimension X3 may equal dimension X2, X3=X2, or even X3>X2, depending on the desired radiation pattern. Usually the spacings X2 and X3 are close to half wavelength (λ/2), and adjustment of the spacings provides adjustment of the resulting AzBW. The splitting coefficient of coupler 22 was selected at 3.5 dB to get low Az sidelobes and high beam cross-over level of 3.5 dB.

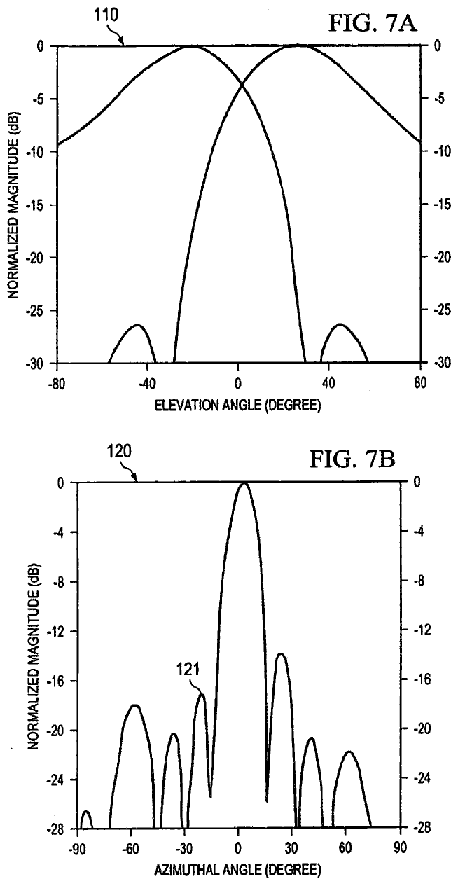

Referring to FIG. 7A, there is shown at 110 a simulated azimuth patterns for both of the beams provided by the antenna 100 shown in FIG. 6, with X3=X2=0.46λ and 2 crossed dipoles in each column 76, separated by 0.87λ As shown, each azimuth pattern has an associated sidelobe that is at least −27 dB below the associated main beam with beam cross-over level of −3.5 dB. Advantageously, the present invention is configured to provide a radiation pattern with low sidelobes in both planes. As shown in FIG. 7B, the low level of upper sidelobes 121 is achieved also in the elevation plane (<−17 dB, which exceeds the industry standard of <−15 dB). As it can be seen in FIG. 6, the amplitude distribution and the low sidelobes in both planes are achieved with small amplitude taper loss of 0.37 dB. So, by selection of a number of 2×2 and 2×3 modules, distance X2 and X3 together with the splitting coefficient of coupler 22, a desirable AzBW together with desirable level of sidelobes is achieved. Vertical dividers 101,102,103,104 can be combined with phase shifters for elevation beam tilting.

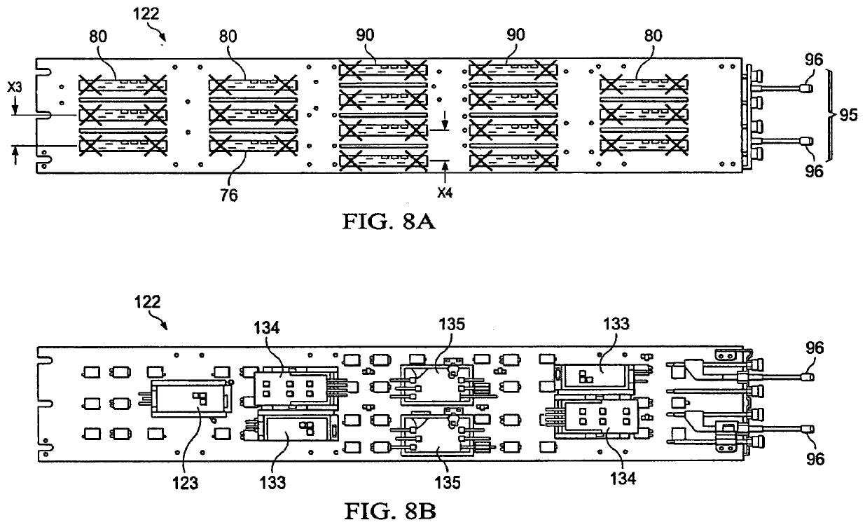

FIG. 8A depicts a practical dual-beam antenna configuration for a 33° AzBW, when viewed from the radiation side of the antenna array, which has three (3) 3-column radiator modules 80 and two (2) 4-column modules 90. Each column 76 has 2 crossed dipoles. Four ports 95 are associated with 2 beams with +45 degree polarization and 2 beams with −45 degree polarization.

FIG. 8B shows antenna 122 when viewing the antenna from the back side, where 2×3 BFN 133 and 2×4 BFN 134 are located together with associated phase shifters/dividers 135. Phase shifters/dividers 135, mechanically controlled by rods 96, provide antenna 130 with independently selectable down tilt for both beams.

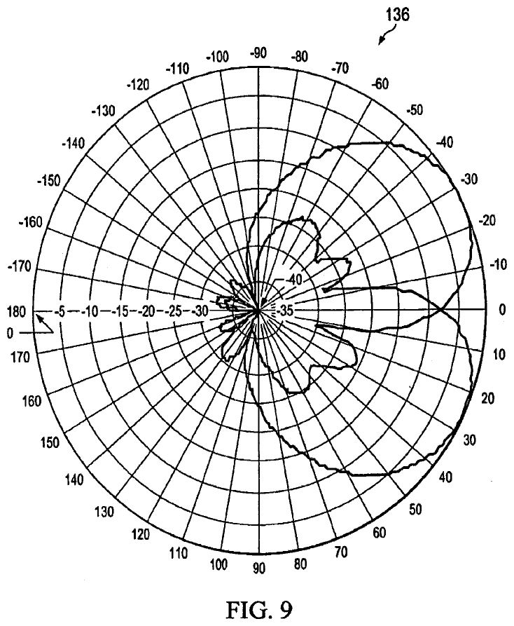

FIG. 9 is a graph depicting the azimuth dual-beam patterns for the antenna array 122 shown in FIG. 8A, 8B, measured at 1950 MHz and having 33 degree AzBW.

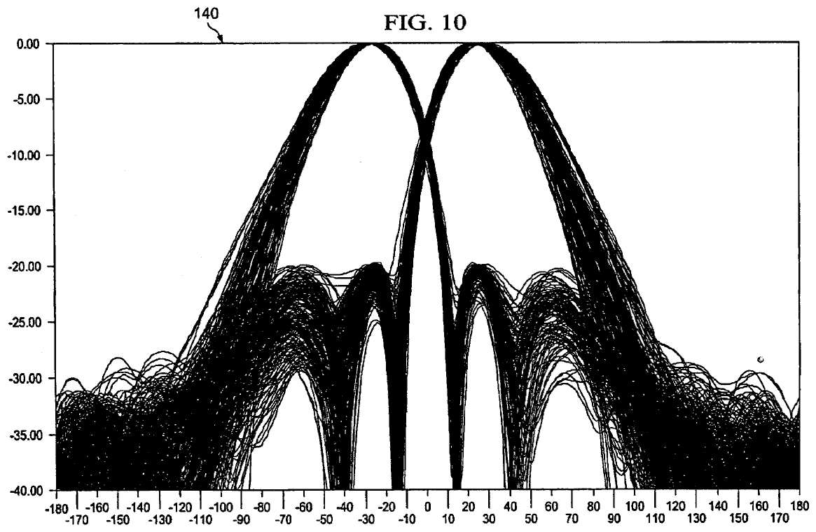

Referring to FIG. 10, there is shown at 140 the dual beam azimuth patterns for the antenna array 122 of FIG. 8A, 8B, measured in the frequency band 1700-2200 MHz. As one can see from FIGS. 9 and 10, low side lobe level (<20 dB) is achieved in very wide (25%) frequency band. The Elevation pattern has low sidelobes, too (<−18 dB).

As can be appreciated in FIGS. 9 and 10, up to about 95% of the radiated power for each main beam, Beam 1 and Beam 2, is directed in the desired sector, with only about 5% of the radiated energy being lost in the sidelobes and main beam portions outside the sector, which significantly reduces interference when utilized in a sectored wireless cell. Moreover, the overall physical dimensions of the antenna 122 are significantly reduced from the conventional 6-sector antennas, allowing for a more compact design, and allowing these sector antennas 122 to be conveniently mounted on antenna towers. Three (3) of the antennas 122 (instead of six antennas in a conventional design) may be conveniently configured on an antenna tower to serve the complete cell, with very little interference between cells, and with the majority of the radiated power being directed into the intended sectors of the cell.

For instance, the physical dimensions of 2-beam antenna 122 in FIG. 8A, 8B are 1.3×0.3 m, the same as dimensions of conventional single beam antenna with 33 degree AzBW.

In other designs based on the modular approach of the present invention, other dual-beam antennas having a different AzBW may be achieved, such as a 25, 35, 45 or 55 degree AzBW, which can be required for different applications. For example, 55 and 45 degree antennas can be used for 4 and 5 sector cellular systems. In each of these configurations, by the combination of the 2×2, 2×3 and 2×4 modules, and the associated spacing X2, X3 and X4 between the radiator columns (as shown in FIGS. 6 and 8A), the desired AzBW can be achieved with very low sidelobes and also adjustable beam tilt. Also, the splitting coefficient of coupler 22 provides another degree of freedom for pattern optimization. In the result, the present invention allows to reduce azimuth sidelobes by 10-15 dB in comparison with prior art.

Though the invention has been described with respect to a specific preferred embodiment, many variations and modifications will become apparent to those skilled in the art upon reading the present application. For example, the invention can be applicable for radar multi-beam antennas. The intention is therefore that the appended claims be interpreted as broadly as possible in view of the prior art to include all such variations and modifications.

That which is claimed is:

1. A multi-beam cellular communication antenna, comprising:
a first subarray that includes M radiating elements that are spaced apart from each other along a row direction, the first subarray further including a 2×M beamforming network that is configured to couple a first input signal and a second input signal to all M radiating elements of the first subarray; and
a second subarray that includes N radiating elements that are spaced apart from each other along the row direction, N being not equal to M, the second subarray spaced apart from the first subarray along a column direction that is perpendicular to the row direction, the second subarray further including a 2×N beamforming network that is configured to couple the first input signal and the second input signal to all N radiating elements of the second subarray,
wherein the 2×M beamforming network includes a hybrid coupler having an unequal power split.

2. The multi-beam cellular communication antenna of claim 1, wherein the multi-beam cellular communication antenna is configured to generate simultaneously a first beam that points in a first direction responsive to the first input signal and a second beam that points in a second direction responsive to the second input signal.

3. The multi-beam cellular communication antenna of claim 2, wherein M=2 and N=3.

4. The multi-beam cellular communication antenna of claim 3, wherein the first subarray and the second subarray are two subarray of an antenna array, and the first subarray is a top subarray or a bottom subarray of the antenna array.

5. The multi-beam cellular communication antenna of claim 2, wherein the hybrid coupler is a 90° hybrid coupler.

6. The multi-beam cellular communication antenna of claim 5, wherein the 2×M beamforming network further includes a 180° splitter.

7. The multi-beam cellular communication antenna of claim 2, wherein the first beam covers a first sector of a cell of a wireless communication system and the second beam covers a second sector of the cell.
